(19) United States
(12) Patent Application Publication
(10) Pub. No.: US 2003/0172386 A1
(43) Pub. Date: Sep. 11, 2003

(54) System and method for sending and receiving information of digital cable broadcasting

(76) Inventors: Han-Seung Koo, Daejeon (KR); Yong-Seong Jo, Jeonju (KR); O-Hyoung Kwon, Daejeon (KR); Chieteuk Ahn, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/032,690

(22) Filed: Dec. 27, 2001

(30) Foreign Application Priority Data
Nov. 2, 2001 (KR) 2001-68245

(51) Int. Cl. H04N 7/173; H04N 7/16; H04B 1/66; H04N 7/12; H04N 11/02; H04N 11/04

(52) U.S. Cl. 725/151; 725/144; 725/131; 375/240.01; 725/146; 725/116

(57) ABSTRACT

Disclosed is a system and method for sending and receiving information of digital cable broadcasting, which comprises: a headend unit for assigning a packet identifier (PID) from within a range of PIDs to tables carrying data according to inclusion of service information (SI), constructing a transport packet (TP), and sending it using an MPEG communication method; and a receiving unit for receiving the TP from the headend unit, checking the PID of the TP to determine whether the TP includes SI, and determining how to process the TP depending on inclusion states of SI in the TP. The PID discriminates a TP including SI from a TP including other messages in transmission of MPEG-2 TPs from the headend unit to the receiving unit.

### BACKGROUND OF THE INVENTION

(a) Field of the Invention

The present invention relates to a system and method for sending and receiving information of digital cable broadcasting. More specifically, the present invention relates to a system and method for sending and receiving information of digital cable broadcasting that is to more rapidly process service information than any other messages transferred on out-of-band channels.

(b) Description of the Related Art

In general, digital cable broadcasting is a system for converting analog broadcast signals to digital codes similar to those used in computers and sending the digital codes to a digital TV picture receiver, which displays the received digital codes to viewers. The digital cable broadcasting employs digital equipment in all processes related to production, sending, and receiving of broadcast programs, and it makes use of its advantageous functions, such as high resolution and data broadcasting.

There are two communication methods using out-of-band channels that are prescribed in the current digital cable broadcasting.

One method uses MPEG-2 (Motion Picture Experts Group 2) transport packets for downward communication from a headend to a subscriber-receiver, and an ATM (Asynchronous Transfer Mode) cell format for upstream communication from the subscriber-receiver to the headend.

MPEG-2 is an image compression method that was standardized as ISO 13818 in 1994 and is now widely used for computer media service (e.g., DVD), broadcasting service (direct satellite broadcasting, cable broadcasting, high-definition TV, etc.), movies, and advertisement editions.

The other method utilizes an SL-ESF (Signaling Link-Extended Super Frame) format for downward communication from the headend to the subscriber-receiver, and an ATM cell format for upstream communication from the subscriber-receiver to the headend.

In the downward communication of the MPEG-2 transport packets using the former method, the subscriber-receiver extracts the received MPEG-2 transport packets based on the packet identifier (PID) included in the transport packets. Subsequently, the messages in the data link layer are reconstructed from the data extracted from the private section of the MPEG-2 transport packets.

To reconstruct the MPEG-2 transport packets, use is made of a payload unit start indicator (PUSI) bit included in the header of the MPEG-2 transport packets. It is then determined from the address-type portion of the header if the messages thus constructed are transmitted to a single cast address or a broadcast address.

The single cast address is for data transmission to an individual set-top-box and the broadcast address is for data transmission to all set-top-boxes.

For a message transmitted to the single cast address, the receiver compares the single cast address with it's own private address and determines whether the message is for it. If the message is destined for the private address, the receiver processes the corresponding message in the next step; otherwise, it discards the message.

For a message transmitted to the broadcast address, the receiver receives the message unconditionally and checks the reception state by a cyclic redundancy check (CRC).

In this manner, the receiver constructs a protocol data unit (PDU) and combines more than one PDU to construct a service data unit (SDU).

The SDU thus constructed has an Internet protocol (IP) datagram form. The receiver extracts the payload portion from the IP datagram to take the message sent from the headend.

In transmission of service information on out-of-band channels by the above procedures, the conventional method for sending and receiving information of digital cable broadcasting encounters several problems related to inefficient transmission, as follows.

The service information refers to a set of additional information in a table format that enables the viewers to see and hear the programs. The service information allows the viewers to choose a desired program via one of at least 100 channels supported in the digital cable broadcasting.

In communication of the service information, the headend receives the service information included in the IP datagram from an application server and inserts additional information before the header of the IP datagram in order to interpret the message in the data link layer of the receiver prior to division of the IP datagram into MPEG-2 transport packets.

The additional information comprises message type, address type, message length, and message version fields, and it has a variable length depending on the address type. But the service information can also be transmitted normally without additional information.

The message type field enables the PID to determine if the message contains the service information, because the service information is transmitted via the private section of the MPEG-2 transport packets. The service information, which is transmitted to the broadcast address, requires no address field.

The message length field is used to construct medium access control (MAC) packets in the data link layer of the receiver and becomes useless when there is no need for forming the MAC packets. The message version field is normally set to “zero” and is thus meaningless. Accordingly, the headend performs an unnecessary process of inserting additional information in transmission of the service information that makes the transmission inefficient. In the case where the headend inserts the IP datagram independently into the 184-byte payload other than the 4-byte header of the MPEG-2 transport packet, the receiver has to extract the IP datagram from the received MPEG-2 transport packet and then extract the payload from the IP datagram so as to acquire service information in the MPEG-2 private section format. As the headend also transmits the IP datagram, a problem related to the inefficient transmission occurs in that the receiver performs an unnecessary step of extracting the data.

On the other hand, U.S. Pat. No. 5,892,910 discloses a communication method for a bidirectional cable TV system, in which the data between the sender's headend equipment are communicated according to the IP protocol and all messages are multiplexed for MPEG-2 communication and sent to the receiver, which then extracts the data from the MPEG-2 transport messages.

Such a communication method for a bidirectional cable TV system has some problems in regard to the complexity of the receiver circuit as well as difficulty in managing the service information in a rapid and efficient manner, because the communication protocol message format for data transmission is too complex and all the data sent to the receiver are multiplexed by the MPEG2 communication system.

### SUMMARY OF THE INVENTION

It is an object of the present invention to provide a system and method for sending and receiving information of digital cable broadcasting that is to more rapidly process service information than any other messages transferred on out-of-band channels from a headend to a receiver in digital cable broadcasting.

In one aspect of the present invention, there is provided a system for sending and receiving information of digital cable broadcasting that includes: a headend unit for assigning a packet identifier (PID) from within a range of PIDs predefined by the system to tables carrying data according to inclusion of service information, constructing a transport packet, and sending the constructed transport packet using a motion picture experts group (MPEG) communication method; and a receiving unit for receiving the transport packet from the headend unit, checking the PID of the transport packet to determine whether the transport packet includes service information, and deciding how to process the transport packet depending on inclusion of service information in the transport packet.

The headend unit and the receiving unit designate the PID of the transport packet containing service information excepting an aggregate event information table (AEIT) and an aggregate extended text table (AETT) as a first specified number, and the PID of the transport packet containing service information including the AEIT or AETT as a second specified number within a defined range of PIDs excepting the first specified number.

The headend unit includes: a service information generator for generating the tables including the service information in MPEG private section format and sending them on an IP datagram; and a transport packet generator for receiving the IP datagram from the service information generator, assigning a PID to construct a transport packet, and outputting the constructed transport packet.

The service information generator uses a PID predefined by the system exclusively for the transport packet including service information so as to discriminate the transport packet including service information from transport packets including other messages.

The service information generator adds an indicator bit to a header of the transport packet so as to discriminate between IP datagrams including different service information.

The service information generator constructs a master guide table (MGT) that provides a version, size, and PID of all other tables, among the tables including service information.

The transport packet generator extracts a payload from the IP datagram received from the service information generator and assigns the PID of the transport packet as the first specified number for the table containing service information excepting the AEIT and the AETT, and as the second specified number for the table containing service information including the AEIT or AETT.

The transport packet generator extracts a payload of the IP datagram received from the service information generator and adds a transport packet header of a predetermined size to construct the final transport packet.

The transport packet generator determines the PID with reference to the MGT received from the service information generator.

The receiving unit includes: a PID checker for checking the PID of the transport packet received from the headend unit and determining whether the PID is in a range of PIDs predefined by the system, to discriminate a transport packet including service information from a transport packet not including service information; a table constructer for receiving the transport packet including service information from the PID checker, extracting the service information from the transport packet, and constructing various tables; and a link layer packet constructer for receiving the transport packet not including service information from the PID checker and constructing a protocol data unit (PDU) and a service data unit (SDU).

The PID checker checks the PID of the transport packet received from the headend unit and decides that the transport packet includes service information when the PID is identical to the first specified number; that the transport packet includes the AEIT or AETT when the PID is identical to the second specified number; or that the transport packet does not include service information when the PID is identical to neither of the first specified number nor the second specified number.

The table constructer extracts service information messages from a private section of the transport packet received from the PID checker and constructs various tables using a table identifier of the extracted service information messages.

In another aspect of the present invention, there is provided a method for sending and receiving information of digital cable broadcasting that includes: (a) a headend assigning a packet identifier (PID)s from within a range of PIDs predefined by the system to tables carrying data according to inclusion of service information, constructing a transport packet, and sending the constructed transport packet to a receiver using a motion picture experts group (MPEG) communication method; and (b) upon reception of the transport packet in the step (a), the receiver checking the PID of the transport packet to determine whether the transport packet includes service information, and deciding how to process the transport packet depending on inclusion of service information in the transport packet.

The step (a) includes the headend and the receiver designating the PID of the transport packet containing service information excepting an aggregate event information table (AEIT) and an aggregate extended text table (AETT) as a first specified number, and the PID of the transport packet containing service information including the AEIT or AETT as a second specified number within a defined range of PIDs excepting the first specified number. The step (a) includes: generating the tables including service information in MPEG private section format and sending them on an IP datagram; and receiving the IP datagram from the service information generating step, assigning a PID to construct a transport packet and sending the constructed transport packet to the receiver.

The transport packet generating step includes: extracting a payload from the IP datagram, and assigning the first specified number for the table containing service information excepting the AEIT and the AETT, and the second specified number for the table containing service information including the AEIT or AETT. The step (a) includes: assigning a PID excepting the first and second specified numbers to the messages not including service information and constructing the transport packet.

The step (b) includes: checking the PID of the transport packet received from the step (a) and determining whether the PID is predefined by the system; when the PID is predefined by the system, deciding that the transport packet includes service information, extracting service information messages from the transport packet, and constructing tables; and when the PID is not predefined by the system, deciding that the transport packet does not include service information, and processing the transport packet in a data link layer.

The PID checking step includes: determining whether the PID of the transport packet corresponds to the first specified number; deciding that the transport packet contains service information excepting the AEIT and the AETT when the PID corresponds to the first specified number; determining whether the PID corresponds to the second specified number when the PID does not correspond to the first specified number; deciding that the transport packet contains service information including the AEIT or AETT when the PID corresponds to the second specified number; and deciding that the transport packet does not include service information when the PID corresponds to neither of the first specified number nor the second number.

The link layer processing step includes: receiving the transport packet not including service information; constructing a protocol data unit; and combining more than one protocol data unit to construct a service data unit.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram showing the construction of a headend unit in a system for sending and receiving information of digital cable broadcasting in accordance with an embodiment of the present invention;

FIG. 2 illustrates the structure of an MPEG-2 transport packet generated from the headend unit;

FIG. 3 is a block diagram showing the construction of a receiving unit of digital cable broadcasting in accordance with an embodiment of the present invention;

FIG. 4 is a flow chart showing a method for sending information from the headend unit in the method for sending and receiving information of digital cable broadcasting in accordance with an embodiment of the present invention; and

FIG. 5 is a flow chart showing a method for receiving information at the receiving unit in the method for sending and receiving information of digital cable broadcasting in accordance with an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

A system according to an embodiment of the present invention comprises a headend unit for constructing MPEG-2 transport packets, and a receiving unit for receiving the MPEG-2 transport packets to construct various information tables and processing information.

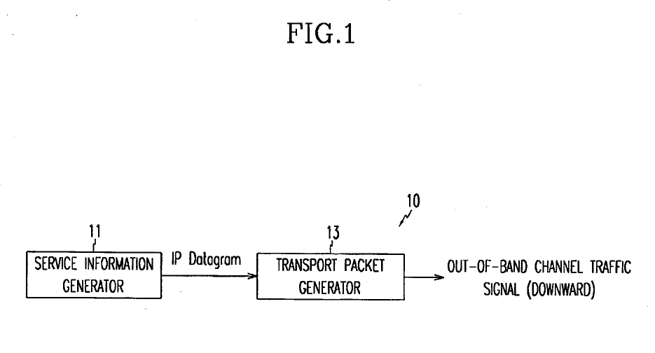

FIG. 1 is a block diagram showing the construction of the headend unit in a system for sending and receiving information of digital cable broadcasting in accordance with an embodiment of the present invention.

As shown in FIG. 1, the headend unit 10 comprises a service information generator 11 for generating tables including service information in a MPEG-2 private section format and sending them on an IP datagram, and a transport packet generator 13 for receiving the IP datagram from the service information generator 11 and assigning a PID to the IP datagram to construct and output MPEG-2 transport packets.

Hence, the headend unit 10 extracts the service information in the MPEG-2 private section format from the payload of the IP datagram without including the IP datagram in the MPEG-2 transport packets, and adds a 4-byte header to the MPEG-2 private section to construct the MPEG-2 transport packets.

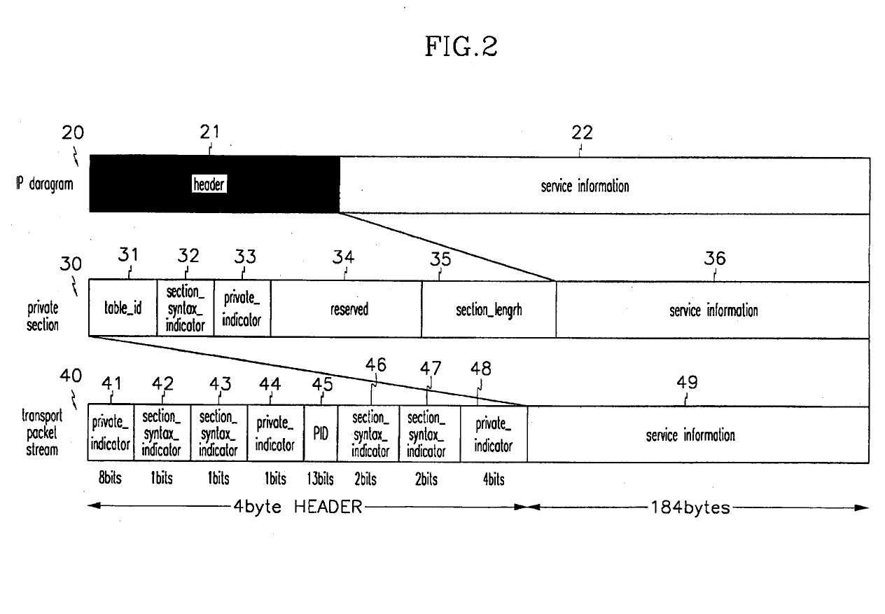

FIG. 2 illustrates the structure of the MPEG-2 transport packet generated from the headend unit.

As shown in FIG. 2, the IP datagram 20 comprises a header 21 and service information 22, and the private section 30 comprises a table identifier 31, a section syntax indicator 32, a private indicator 33, a section length 35, and service information 36.

A transport packet stream 40 comprises a sync byte 41, a transport error indicator 42, a payload unit start indicator 43, a transport priority 44, a PID 45, a transport scrambling device 46, an adaptation field control 47, a continuity counter 48, and service information 49.

The transport packet generator 13 extracts the payload of the IP datagram received from the service information generator 11 and adds 4-byte MPEG-2 transport packet headers 41 to 48 and 184-byte service information 49 to construct the 188-byte MPEG-2 transport packet 40.

The PID 45 is assigned to the MPEG-2 transport packet 40 having a 4 byte header, and it is used to discriminate the MPEG-2 transport packets including service information from those including other messages.

In the system according to an embodiment of the present invention, the PID for a transport packet including service information has a first specified number designated as 0x1FFC, lest it should be used for transport packets including messages other than the service information.

When the application server of the headend unit 10 generating the service information constructs a master guide table (MGT), the PID for an MPEG-2 transport packet including an aggregate event information table (AEIT) and an aggregate extended text table (AETT) has a second specified number designated with a value other than that of the first specified number, within a defined range.

The MGT provides version, size, and PID for all tables except a system time table (STT). The AEIT provides information for events on a virtual channel, and the AETT provides a detailed description of the virtual channel and the events.

The transport packet generator 13 uses the payload unit start indicator's bit included in the header of the MPEG-2 transport packet to discriminate the IP datagram including the service information from those including other service information.

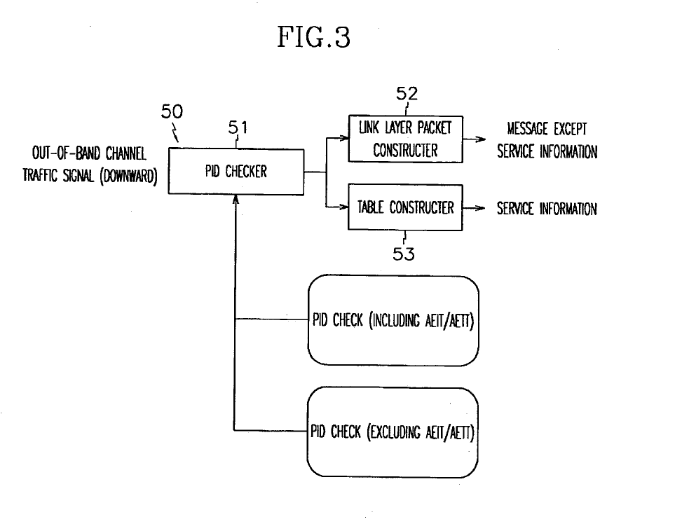

FIG. 3 is a block diagram showing the construction of the receiving unit of the system of digital cable broadcasting in accordance with an embodiment of the present invention.

As shown in FIG. 3, the receiving unit 50 comprises a PID checker 51 for checking the PID from the MPEG-2 transport packet received from the transport packet generator 13 of the headend unit 10 via the out-of-band channel and determining if the transport packet includes service information; a table constructer 53 for, upon receipt of a transport packet including service information, extracting service information from the transport packet received from the PID checker 51 and constructing various tables; and a link layer packet constructer 52 for, upon receipt of a transport packet not including service information, constructing a protocol data unit (PDU) according to the regulation of the SCTE DVS 178 and combining more than one PDU to construct a service data unit (SDU).

The receiving unit 50 separately manages the first and second specified numbers for PIDs of the MPEG-2 transport packet including service information on agreement with the headend unit 10.

The PID checker 51 checks whether the PID of the MPEG-2 transport packet is identical to the first specified number, 0x1FFC. If the PID is 0x1FFC, the PID checker 51 determines that the MPEG-2 transport packet includes service information, and sends the transport packet to the table constructer 53.

If the PID is not identical to the first specified number, the PID checker 51 checks whether the PID corresponds to the second specified number separately assigned for AEIT and AETT.

When the PID of the MPEG-2 transport packet is identical to the second specified number, the PID checker 51 sends the MPEG-2 transport packet to the table constructor 53. Otherwise, when the PID is not the first or second specified number, the PID checker 51 determines that the MPEG-2 transport packet does not include service information, and sends the MPEG-2 transport packet to the link layer packet constructer 52.

Accordingly, the receiving unit 50 can discriminate the transport packet including AEIT and AETT from other transport packets received via out-of-band channels.

The table constructer 53 extracts service information messages from the private section of the MPEG-2 transport packet received from the PID checker 51 and uses the table identifiers of the extracted service information messages to construct a network information table (NIT), a network text table (NTT), a short-form virtual channel table (S-VCT), a long-form virtual channel table (L-VCT), and a system time table (STT).

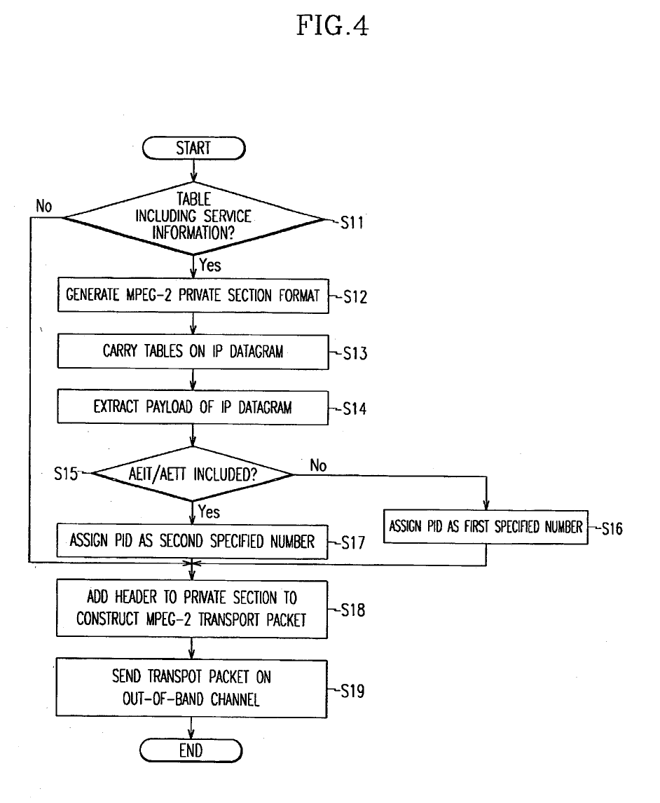

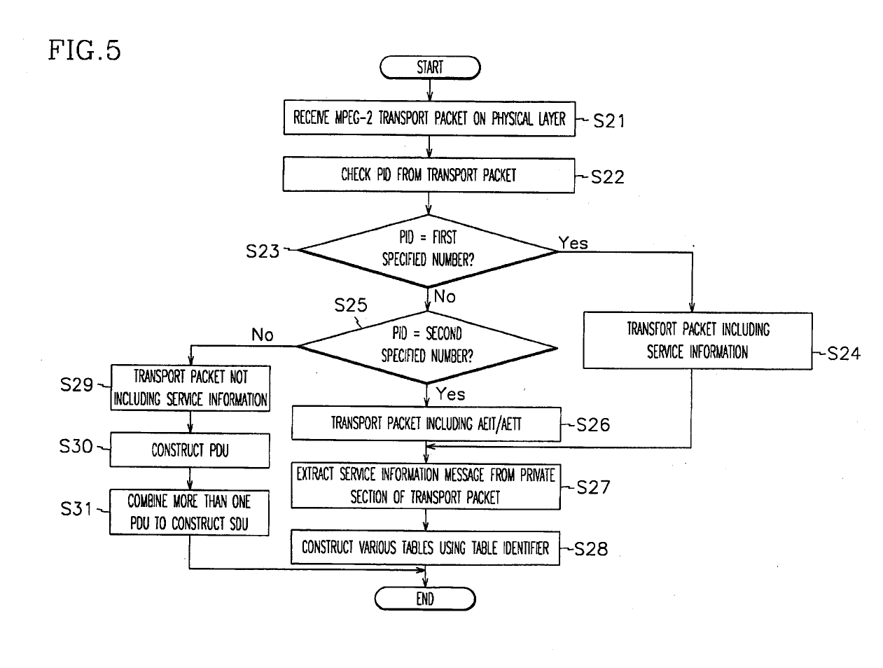

Next, a description will be given to an operation of the system for sending and receiving information of digital cable broadcasting in accordance with an embodiment of the present invention with reference to FIGS. 4 and 5.

FIG. 4 is a flow chart showing a method for sending information from the headend unit in the method for sending and receiving information of digital cable broadcasting in accordance with an embodiment of the present invention.

As shown in FIG. 4, the service information generator 11 of the headend unit 10 determines in step S11 whether the data-carrying tables include service information. The service information generator 11 generates tables including service information in the MPEG-2 private section format, in step S12, and sends the generated service information tables on the IP datagram 20 to the transport packet generator 13, in step S13.

The transport packet generator 13 extracts the payload of the IP datagram 20 received from the service information generator 11, in step S14, and determines in step S15 whether the service information tables include an AEIT/AETT.

If the AEIT/AETT is not included, the transport packet generator 13 assigns a first specified number, 0x1FFC as a PID, in step S16. Otherwise, if the AEIT/AETT is included, the transport packet generator 13 examines the PID from the MGT and assigns a second specified number, in step S17.

In constructing the MGT among the service information tables, the transport packet generator 13 assigns the PID of the AEIT/AETT as the second specified number within a predefined range of PIDs on agreement between the headend unit 10 and the receiving unit 50. Once the PID is assigned, the transport packet generator 13 adds a 4 byte transport packet header to the private section 30 to construct a 188-byte MPEG-2 transport packet 40, in step S18.

If the service information generator 11 determines in step S11 that the tables do not include service information, the transport packet generator 13 constructs the transport packet using a PID of other than the first and second specified numbers so as to discriminate it from those including service information, in step S18.

Once the MPEG-2 transport packet construction is completed, the transport packet generator 13 sends the transport packet to the receiving unit 50 via the out-of-band channel, in step S19.

FIG. 5 is a flow chart showing a method for receiving information at the receiving unit in the method for sending and receiving information of digital cable broadcasting in accordance with an embodiment of the present invention.

As shown in FIG. 5, the PID checker 51 receives an MPEG-2 transport packet through a physical layer, in step S21, and checks the PID of the transport packet, in step S22.

The PID checker 51 determines in step S23 whether the PID of the transport packet is identical to the first specified number. If so, the PID checker 51 considers that the transport packet includes service information, and sends the transport packet to the table constructer 53, in step S24.

If the PID of the transport packet is not identical to the first specified number, the PID checker 51 determines in step S25 whether the PID corresponds to the second specified number. If so, the PID checker 51 considers that the transport packet includes an AEIT/AETT among the service information tables, and sends the transport packet to the table constructor 53, in step S26.

Upon receiving the transport packet from the PID checker 51, the table constructer 53 extracts service information messages from the private section of the MPEG-2 transport packet, in step S27, and uses the table identifiers of the extracted service information messages to construct various tables, in step S28.

If the PID does not correspond to the second specified number, the PID checker 51 considers that the MPEG-2 transport packet does not include service information, and sends the MPEG-2 transport packet to the link layer packet constructer 52, in step S29.

The link layer packet constructer 52 constructs a PDU in the data link layer, in step S30, and combines more than one PDU to construct an SDU, in step S31.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

The system and method for sending and receiving information of digital cable broadcasting according to the present invention makes use of a PID predefined by the system to discriminate the transport packet including service information from the transport packet including other messages in transmission of MPEG-2 transport packets from the headend unit to the receiving unit.

The receiving unit gives a priority to the transport packet including service information using the PID predefined by the system in extraction to construct a table including service information, decides that the transport packet having a PID not predefined by the system does not include service information, and processes the transport packet not including service information in the data link layer.

Accordingly, the present invention eliminates a step of disassembling and reconstructing frames in the data link layer of the receiving unit and enables processing of the messages including service information more rapidly than any other messages and simplifies the circuit of the receiving unit.

What is claimed is:

1. A system for sending and receiving information of digital cable broadcasting, comprising:
a headend unit for assigning a packet identifier (PID) from within a range of PIDs predefined by the system to tables carrying data according to inclusion states of service information, constructing a transport packet, and sending the constructed transport packet using a motion picture experts group (MPEG) communication method; and
a receiving unit for receiving the transport packet from the headend unit, checking the PID of the transport packet to determine whether the transport packet includes service information, and determining how to process the transport packet according to determination results of inclusion of service information.

2. The system as claimed in claim 1, wherein the headend unit and the receiving unit designate the PID of the transport packet containing service information excepting an aggregate event information table (AEIT) and an aggregate extended text table (AETT) as a first specified number, and the PID of the transport packet containing service information including the AEIT and AETT as a second specified number within a defined range of PIDs excepting the first specified number.

3. The system as claimed in claim 1, wherein the headend unit comprises:
a service information generator for generating the tables including the service information in MPEG private section format and sending them on an Internet protocol (IP) datagram; and
a transport packet generator for receiving the IP datagram from the service information generator, assigning a PID to construct a transport packet, and outputting the constructed transport packet.

4. The system as claimed in claim 3, wherein the service information generator uses a PID predefined by the system exclusively for the transport packet including service information so as to discriminate the transport packet including service information from transport packets including other messages.

5. The system as claimed in claim 3, wherein the service information generator adds an indicator bit to a header of the transport packet so as to discriminate between IP datagrams including different service information.

6. The system as claimed in claim 3, wherein the service information generator constructs a master guide table (MGT) that provides a version, size, and PID of all other tables from among the tables including service information.

7. The system as claimed in claim 3, wherein the transport packet generator designates the PID of the transport packet containing service information excepting an AEIT and an AETT as a first specified number, and the PID of the transport packet containing service information including the AEIT and AETT as a second specified number within a range of PIDs defined by the headend unit and the receiving unit excepting the first specified number, the transport packet generator extracting a payload from the IP datagram received from the service information generator and assigning the PID of the transport packet as the first specified number for the table containing service information excepting the AEIT and the AETT, and as the second specified number for the table containing service information including the AEIT or AETT.

8. The system as claimed in claim 3, wherein the transport packet generator extracts a payload of the IP datagram received from the service information generator and adds a transport packet header of a predetermined size to construct the final transport packet.

9. The system as claimed in claim 3, wherein the transport packet generator constructs an MGT that provides the version, size, and PID of all other tables from among the tables including service information, and determines the PID with reference to the MGT received from the service information generator.

10. The system as claimed in claim 1, wherein the receiving unit comprises:
a PID checker for checking the PID of the transport packet received from the headend unit and determining whether the PID is in a range of PIDs predefined by the system, to discriminate a transport packet including service information from a transport packet not including service information;
a table constructer for receiving the transport packet including service information from the PID checker, extracting the service information from the transport packet, and constructing various tables; and
a link layer packet constructer for receiving the transport packet not including service information from the PID checker and constructing a protocol data unit (PDU) and a service data unit (SDU).

11. The system as claimed in claim 10, wherein the PID checker designates the PID of the transport packet containing service information excepting an AEIT and an AETT as a first specified number, and the PID of the transport packet containing service information including the AEIT or AETT as a second specified number within a range of PIDs defined by the headend unit and the receiving unit excepting the first specified number,
the PID checker checking the PID of the transport packet received from the headend unit and determining that the transport packet includes service information when the PID is identical to the first specified number, determining that the transport packet includes the AEIT or AETT when the PID is identical to the second specified number, or determining that the transport packet does not include service information when the PID is identical to neither of the first specified number nor the second specified number.

12. The system as claimed in claim 10, wherein the table constructer extracts service information messages from a private section of the transport packet received from the PID checker and constructs various tables using a table identifier of the extracted service information messages.

13. A method for sending and receiving information of digital cable broadcasting, comprising:
(a) a headend assigning a packet identifier (PID) from within a range of predefined PIDs to tables carrying data according to inclusion states of service information, constructing a transport packet, and sending the constructed transport packet to a receiver using a motion picture experts group (MPEG) communication method; and
(b) upon reception of the transport packet in the step (a), the receiver checking the PID of the transport packet to determine whether the transport packet includes service information, and determining how to process the transport packet according to checking results.

14. The method as claimed in claim 13, wherein the step (a) comprises the headend and the receiver designating the PID of the transport packet containing service information excepting an aggregate event information table (AEIT) and an aggregate extended text table (AETT) as a first specified number, and the PID of the transport packet containing service information including the AEIT and AETT as a second specified number within a defined range of PIDs excepting the first specified number.

15. The method as claimed in claim 13, wherein the step (a) comprises:
generating the tables including service information in MPEG private section format and sending them on an IP datagram; and
receiving the IP datagram from the service information generating step, assigning a PID to construct a transport packet and sending the constructed transport packet to the receiver.

16. The method as claimed in claim 15, wherein the transport packet generating step comprises:
the headend and the receiver designating the PID of the transport packet containing service information excepting an AEIT and an AETT as a first specified number, and the PID of the transport packet containing service information including the AEIT and AETT as a second specified number within a defined range of PIDs excepting the first specified number, and
extracting a payload from the IP datagram, and assigning the first specified number in case of containing service information excepting the AEIT and the AETT, and the second specified number in case of containing service information including the AEIT or AETT.

17. The method as claimed in claim 13, wherein the step (a) comprises:
the headend and the receiver designating the PID of the transport packet containing service information excepting an AEIT and an AETT as a first specified number, and the PID of the transport packet containing service information including the AEIT and AETT as a second specified number within a defined range of PIDs excepting the first specified number, and
assigning a PID excepting the first and second specified numbers to the messages not including service information and constructing the transport packet.

18. The method as claimed in claim 13, wherein the step (b) comprises:
checking the PID of the transport packet received from the step (a) and determining whether the PID is predefined by the system;
when the PID is predefined by the system, determining that the transport packet includes service information, extracting service information messages from the transport packet, and constructing tables; and
when the PID is not predefined by the system, determining that the transport packet does not include service information, and processing the transport packet in a data link layer.

19. The method as claimed in claim 18, wherein the PID checking step comprises:
the headend unit and the receiving unit designating the PID of the transport packet containing service information excepting an AEIT and an AETT as a first specified number, and the PID of the transport packet containing service information including the AEIT and AETT as a second specified number within a defined range of PIDs excepting the first specified number,
determining whether the PID of the transport packet corresponds to the first specified number;
determining that the transport packet contains service information excepting the AEIT and the AETT when the PID corresponds to the first specified number;
determining whether the PID corresponds to the second specified number when the PID does not correspond to the first specified number;
determining that the transport packet contains service information including the AEIT and AETT, when the PID corresponds to the second specified number; and
determining that the transport packet does not include service information when the PID does not correspond to the second specified number but has another specified number excepting the first and second specified numbers.

20. The method as claimed in claim 18, wherein the link layer processing step comprises:
receiving the transport packet not including service information;
constructing a protocol data unit; and
combining more than one protocol data unit to construct a service data unit.
